(19) United States
(12) Patent Application Publication
(10) Pub. No.: US 2015/0276674 A1
(43) Pub. Date: Oct. 1, 2015

(54) IMMUNOASSAYS USING COLLOIDAL CRYSTALS

(71) Applicant: LI-COR, INC., Lincoln, NE (US)

(72) Inventors: Michael D. Furtaw, Lincoln, NE (US); Jon P. Anderson, Lincoln, NE (US); Mary J. Wirth, West Lafayette, IN (US); Robert Birdsall, West Lafayette, IN (US); Yimin Hua, Arlington, MA (US); Pei-Hsun Wei, West Lafayette, IN (US)

(73) Assignees: LI-COR, INC., Lincoln, NE (US); PURDUE RESEARCH FOUNDATION, West Lafayette, IN (US)

(21) Appl. No.: 14/668,840

(22) Filed: Mar. 25, 2015

Related U.S. Application Data
(60) Provisional application No. 61/970,818, filed on Mar. 26, 2014.
(60) Provisional application No. 61/970,857, filed on Mar. 26, 2014.

(51) Int. Cl. G01N 27/447

(52) U.S. Cl. CPC G01N 27/44756

(57) ABSTRACT

The present invention provides systems, methods and kits which enable or utilize an immunologically-based assay, such as a Western immunoassay, to separate, detect or to monitor an analyte or a mixture of analytes such as biomolecules.

### CROSS-REFERENCES TO RELATED APPLICATIONS

This application claims the benefit of U.S. Provisional Application Nos. 61/970,818, and 61/970,857, both filed Mar. 26, 2014, the disclosures of which are incorporated by reference in their entireties for all purposes. In addition, this application incorporates by reference the disclosure of U.S. patent application Ser. No. 14/668,485, filed Mar. 25, 2015 in its entirety.

### STATEMENT AS TO RIGHTS TO INVENTIONS MADE UNDER FEDERALLY SPONSORED RESEARCH AND DEVELOPMENT

This invention was made with government support under CA161772 and GM112387 awarded by the National Institutes of Health. The government has certain rights in the invention.

### BACKGROUND OF THE INVENTION

Western blotting is a very useful and common laboratory procedure. In the typical procedure, protein mixtures are separated on polyacrylamide gel into bands using an applied electric field. After the proteins are separated into bands, the separated bands are transferred to a membrane. After transfer, the separated proteins are probed with primary and secondary antibodies for detection. The detection can be accomplished via radioactivity, chemiluminescence, fluorescence, or absorbance. The most common detection method is chemiluminescence; however, in order to detect multiple analytes simultaneously, fluorescence has recently gained popularity.

Western blotting is time consuming and laborious due to the number of steps involved in the process. Western blotting requires gel electrophoresis to separate the proteins. The proteins are then transferred to a membrane (e.g., nitrocellulose), where they are normally identified with a primary antibody and detected with a secondary antibody.

More recently, other Western blot techniques have been developed (W. Pan et al., Anal. Chem. 2010, 82, 3974-3976). For example, a microfluidic Western blot has been developed that incorporates molecular weight markers and has good capacity to analyze multiple proteins simultaneously. However, this technique requires transfer from a polyacrylamide gel to a polyvinylidene fluoride (PVDF) membrane.

In view of the foregoing, what is needed in the art are new systems and methods for separating mixtures of biologically interesting molecules. The present invention satisfies these and other needs.

### BRIEF SUMMARY OF THE INVENTION

The present invention provides systems and methods which enable or utilize an immuno-based assay, such as a Western immunoassay, to separate, detect or to monitor an analyte such as a biomolecule.

As such, in one embodiment, the present invention provides an electrophoresis system useful for a Western immunoassay, the electrophoresis system comprising:
a substrate comprising a plurality of colloidal nanoparticles;
a power supply for applying a voltage along the substrate; and
a means for applying a detection reagent.

In another embodiment, the present invention provides a Western immunoassay method, the method comprising:
resolving at least one analyte on a substrate comprising a plurality of colloidal nanoparticles;
immobilizing the at least one analyte on the substrate to form an immobilized at least one analyte; and
detecting the immobilized at least one analyte.

In yet another embodiment, the present invention provides a kit, the kit comprising:
a substrate comprising a plurality of colloidal nanoparticles;
a detection reagent; and
instructions for use.

These and other aspects, objects and advantages will become more apparent when read with the detailed description and figures which follow.

### BRIEF DESCRIPTION OF THE DRAWINGS

FIGS. 1A-B illustrate a device or system of the present invention FIG. 1A shows a separation bed; FIG. 1B shows a means for applying a detection reagent.

FIGS. 2A-C illustrate a device of the present invention. FIG. 2A shows a side view of a separation bed; FIG. 2B shows a top view of a separation bed of the present invention; FIG. 2C shows a top view of a separation bed with a separated analyte.

FIGS. 3A-D illustrate a device embodiment or system of the present invention. FIG. 3A shows a top view of a separation bed; FIG. 3B shows a side view of an embodiment of a separation bed of the present invention; FIG. 3C shows a top view of a separation bed with a analyte; FIG. 3D shows a top view of a separated analyte in separation bed.

FIGS. 4A-C illustrate a device or system of the present invention for parallel analysis of multiple samples. FIG. 4A shows a side view of a separation bed; FIG. 4B shows a top view of an embodiment of a separation bed of the present invention; FIG. 4C shows a top view of a separated analyte in separation bed of the present invention.

FIGS. 5A-G illustrate a device or system embodiment of the present invention. FIG. 5A shows a top view of a separation bed; FIG. 5B shows a side view of an embodiment of a separation bed of the present invention; FIG. 5C shows a top view of a device of the present invention; FIG. 5D shows a side view of an embodiment of the present invention; FIG. 5E shows a top view of a device of the present invention; FIG. 5F shows a perspective view of a device of the present invention; FIG. 5G shows a perspective view of a device of the present invention.

FIGS. 6A-D illustrate a device or system of the present invention for resolution of analytes in two dimensions. FIG. 6A shows a top view of one embodiment showing multiple separation beds; FIG. 6B shows a top view of one embodiment showing multiple separation beds with a sample; FIG. 6C shows a top view of one embodiment showing multiple separation beds with separated analytes; FIG. 6D shows a top view of one embodiment showing multiple separation beds with separated analytes in 2-dimensions.

FIGS. 7A-H show that protein spots incubated with the protein precipitation solution (40% methanol and 10% TCA). Spots were mainly retained on the silica coated slides 7A-7D, while protein spots that were not incubated with the protein precipitation solution were mostly removed during the subsequent incubation and/or wash steps 7E-7H.

FIG. 8 illustrates IEF separation of labeled carbonic anhydrase I and II and lectin glycoprotein in a 1.8 cm long microchannel.

FIG. 9 illustrates one embodiment of an image of labeled proteins.

FIG. 10 illustrates spheres in a body centered cubic (BCC) configuration in accordance with an embodiment.

FIG. 11 illustrates one unit cell of spheres in a body centered cubic configuration in accordance with an embodiment.

FIG. 12 illustrates a cross section of uncoated packed spherical nanoparticles in accordance with an embodiment.

FIG. 13 illustrates a cross section of packed spherical nanoparticles with a post-packing coating in accordance with an embodiment.

FIG. 14A-B illustrate a cross section of packed spherical nanoparticles with a hard pre-packing coating in accordance with an embodiment (A); and a cross section of packed spherical nanoparticles with a compressible pre-packing coating in accordance with an embodiment (B).

### DETAILED DESCRIPTION OF THE INVENTION

### I. Definitions

As used herein, certain terms may have the following defined meanings. As used in the specification and claims, the singular form “a,” “an” and “the” include singular and plural references unless the context clearly dictates otherwise. For example, the term “a cell” includes a single cell as well as a plurality of cells, including mixtures thereof.

The term “about,” as used to modify a numerical value, indicates a defined range around that value. If “X” were the value, “about X” would generally indicate a value from 0.95X to 1.05X. Any reference to “about X” specifically indicates at least the values X, 0.95X, 0.96X, 0.97X, 0.98X, 0.99X, 1.01X, 1.02X, 1.03X, 1.04X, and 1.05X. Thus, “about X” is intended to teach and provide written description support for a claim limitation of, e.g., “0.98X.” When the quantity “X” only includes whole-integer values (e.g., “X carbons”), “about X” indicates from (X−1) to (X+1). In this case, “about X” as used herein specifically indicates at least the values X, X−1, and X+1.

A “silica colloidal crystal” includes a plurality of silica particles packed in a repeating pattern in two or three dimensions. The crystal can be monocrystalline (containing a single unit cell having one periodic arrangement) or polycrystalline (including two or more unit cells having the same or different periodic arrangements, forming a plurality of crystal grains). The arrangement of the silica particles in the unit cell is analogous to the arrangement of atoms or molecules in a conventional crystal. The silica colloidal crystal contains space (i.e., interstitial space) between individual particles.

“Introducing” a sample into a separation bed can include filling (or partially filling) the interstitial spaces between particles with the sample, or as otherwise known in the art. Introducing the sample can include injection of the sample via pressure, gravity, or electrostatic force.

An “array” refers to a grouping or an arrangement, without necessarily being a regular arrangement.

The terms “antibody,” “immunoglobulin”, “Ab,”, “Ig,” “anti-target,” and like terms include a polypeptide encoded by an immunoglobulin gene or functional fragments thereof that specifically binds and recognizes an antigen. Immunoglobulin genes include the kappa, lambda, alpha, gamma, delta, epsilon, and mu constant region genes, as well as the myriad immunoglobulin variable region genes. Light chains are classified as either kappa or lambda. Heavy chains are classified as gamma, mu, alpha, delta, or epsilon, which in turn define the immunoglobulin classes, IgG, IgM, IgA, IgD and IgE, respectively. The term antibody activity, or antibody function, refers to specific binding of the antibody to the antibody target.

An exemplary immunoglobulin (antibody) structural unit comprises a tetramer. Each tetramer is composed of two identical pairs of polypeptide chains, each pair having one “light” (about 25 kDa) and one “heavy” chain (about 50-70 kDa). The N-terminus of each chain defines a variable region of about 100 to 110 or more amino acids primarily responsible for antigen recognition. The terms “variable heavy chain,” “V_{H},” or “VH” refer to the variable region of an immunoglobulin heavy chain, including an Fv, scFv, dsFv or Fab; while the terms “variable light chain,” “V_{L}” or “VL” refer to the variable region of an immunoglobulin light chain, including of an Fv, scFv, dsFv or Fab. The C-terminus of the heavy chains forms the constant region, often referred to as the “Fc” region.

Examples of antibody fragments that bind antigens include, but are not limited to, complete antibody molecules, antibody fragments, such as Fv, single chain Fv (scFv), complementarity determining regions (CDRs), VL (light chain variable region), VH (heavy chain variable region), Fab, F(ab′)2 and any combination of those or any other functional portion of an immunoglobulin peptide capable of binding to target antigens (see, e.g., FUNDAMENTAL IMMUNOLOGY (Paul ed., 4th ed. 2001). As appreciated by one of skill in the art, various antibody fragments can be obtained by a variety of methods, for example, digestion of an intact antibody with an enzyme, such as pepsin; or de novo synthesis. Antibody fragments are often synthesized de novo chemically or expressed using recombinant DNA methodology. Thus, the term antibody, as used herein, includes antibody fragments either produced by the modification of whole antibodies, or expressed using recombinant DNA methodologies (e.g., single chain Fv) or those identified using phage display libraries (see, e.g., McCafferty et al., (1990) Nature 348:552). The term “antibody” also includes bivalent or bispecific molecules, diabodies, triabodies, and tetrabodies. Bivalent and bispecific molecules are described in, e.g., Kostelny et al. (1992) J. Immunol. 148:1547, Pack and Pluckthun (1992) Biochemistry 31:1579, Hollinger et al. (1993), PNAS. USA 90:6444, Gruber et al. (1994) J Immunol. 152:5368, Zhu et al. (1997) Protein Sci. 6:781, Hu et al. (1996) Cancer Res. 56:3055, Adams et al. (1993) Cancer Res. 53:4026, and McCartney, et al. (1995) Protein Eng. 8:301.

The term “polyclonal antibody” includes a heterogeneous population of antibodies raised against an antigen. The antibodies within the population usually bind to different epitopes on the antigen. Polyclonal antibodies can be useful for detecting an antigen in a broader range of conditions than monoclonal antibodies, which are specific for a particular epitope.

The term “monoclonal antibody” includes a clonal population of antibodies that bind to the same epitope on an antigen. Monoclonal antibodies can be made by selecting a single member of a heterogeneous population of antibodies for antigen binding, and clonally expanding the cell that produces that antibody in a hybridoma cell (see, e.g., Kohler and Milstein (1975) Nature 256:495). Recombinant methods are also used for preparing monoclonal antibodies (see, e.g., Chadd and Chamow (2001) Curr. Opin. Biotechnol. 12:188094).

The phrase “specifically (or significantly or selectively) binds to” when referring to a given target, includes a binding reaction which is determinative of the presence of the target in the presence of a heterogeneous population of proteins and other biologics. Thus, under designated immunoassay conditions, a target-specific antibody will bind to the target and not bind in a significant amount to other proteins and molecules present in the sample. Specific binding to an antibody under such conditions may require an antibody that is selected for its specificity for a particular target. For example, antibodies raised against a selected target can be further selected to obtain antibodies that do not bind to other molecules.

One of skill will understand that “specific” or “significant” binding are not intended to be absolute terms. For example, if an antibody does not significantly bind to a particular epitope, it binds with at least 5-fold, 8-fold, 10-fold, 20-fold, 50-fold, 80-fold, or 100-fold reduced affinity as compared to the epitope against which the antibody was raised. For example, a target-specific antibody does not significantly bind to a non-target if it binds to the latter with less than 20%, 10%, 5%, 1%, 0.5%, 0.1%, 0.05%, 0.01% or less affinity than to the target. Binding affinity can be determined using techniques known in the art, e.g., ELISAs. Affinity can be expressed as dissociation constant (Kd or K_{D}). A relatively higher Kd indicates lower affinity. Thus, for example, the Kd of a target-specific antibody for the target will typically be lower by a factor of at least 5, 8, 10, 15, 20, 50, 100, 500, 1000, or more than the Kd of the target-specific antibody with a different molecule. One of skill will understand how to design controls to indicate non-specific binding and compare relative binding levels.

The term “primary antibody” will be understood by one of skill to refer to an antibody or fragment thereof that specifically binds to an analyte (e.g., substance, antigen, component) of interest. The primary antibody can further comprise a tag, e.g., for recognition by a secondary antibody or associated binding protein (e.g., GFP, biotin, or streptavidin). A binding moeity such as an aptamer or affibody can also be used.

The term “secondary antibody” refers to an antibody that specifically binds to a primary antibody. A secondary antibody can be specific for the primary antibody (e.g., specific for primary antibodies derived from a particular species) or a tag on the primary antibody (e.g., GFP, biotin, or streptavidin). A secondary antibody can be bispecific, e.g., with one variable region specific for a primary antibody, and a second variable region specific for a bridge antigen. A binding moeity such as an aptamer or affibody can also be used.

A “biological marker” is a biomolecule, a biochemical label, or other biological motif that identifies a structure or function of interest in a biological specimen/sample.

“Biological assay” is a method of biological analysis, in which a biological substrate of interest is reacted with chemicals or biochemicals, where the reaction can be used to characterize the substrate (e.g., by function, presence or absence, etc.). Examples of biological assays are innumerable, and include DNA sequencing, restriction fragment length polymorphism determination, Southern blotting and other forms of DNA hybridization analysis, determination of single-strand conformational polymorphisms, comparative genomic hybridization, mobility-shift DNA binding assays, protein gel electrophoresis, Northern blotting and other forms of RNA hybridization analysis, protein purification, chromatography, immunoprecipitation, protein sequence determination, Western blotting (protein immunoblotting), ELISA and other forms of antibody-based protein detection, isolation of biomolecules for use as antigens to produce antibodies, PCR, RT PCR, differential display of mRNA by PCR, and the like. Protocols for carrying out these and other forms of assays are readily available to those skilled in the art.

“Detecting” refers to determining the presence, absence, or amount of an analyte in a sample, or as otherwise known in the art. It can include quantifying the amount of the analyte in a sample or per cell in a sample.

A “biomolecule” includes a molecule of a type typically found in a biological system, whether such molecule is naturally occurring or the result of some external disturbance of the system (e.g., a disease, poisoning, genetic manipulation, etc.), as well as synthetic analogs and derivatives thereof. Non-limiting examples of biomolecules include amino acids (naturally occurring or synthetic), peptides, polypeptides, proteins, glycosylated and unglycosylated proteins (e.g., polyclonal and monoclonal antibodies, receptors, interferons, enzymes, etc.), nucleosides, nucleotides, oligonucleotides (e.g., DNA, RNA, PNA oligos), polynucleotides (e.g., DNA, cDNA, RNA, etc.), carbohydrates, hormones, haptens, steroids, and toxins, etc. Biomolecules may be isolated from natural sources, or they may be synthetic.

The term “equilibrium dissociation constant” or “affinity” abbreviated (Kd or K_{D}), refers to the dissociation rate constant (k_{d}, time⁻¹) divided by the association rate constant (kₐ, time⁻¹ M⁻¹). Equilibrium dissociation constants can be measured using any known method in the art. As an example, the affinity for Protein A/G for Ig molecules is typically in the low nM range. Antibodies with high affinity for an antibody target have a monovalent affinity less than about 100 nM, and often less than about 50 nM, 1 nM, 500 pM or about 50 pM as determined by surface plasmon resonance analysis performed at 37° C.

A “specific binding agent” is an agent that recognizes and binds substantially preferentially to a biological marker of interest, so that the agent provides potentially useful information about the biological marker. Examples of specific binding agents are polyclonal and monoclonal antibodies for an antigen of interest; proteins and protein derivatives that interact or bind to receptors (for example, calmodulin or a labeled calmodulin derivative) and nucleic acid probes such as DNA and RNA probes.

The term “sample,” e.g., with reference to a detection assay, is used broadly. The term can refer to a sample at any stage, e.g., a crude biological sample, a sample of pre-selected cells, a component of a biological sample, a sample deposited on a substrate, or separated electrophoretically or using chromatography. Typical examples of a sample includes cell lysate, a solution of proteins or other biomolecules, a population of cells, a biopsy, biological fluid (e.g., blood, blood component, mucus, urine, lymph, saliva, tears, etc.), or a tissue section. A “sample” can be any mixture or pure substance having at least one analyte, or a sample as otherwise known in the art. An “analyte” includes a substance of interest such as a biomolecule. Biomolecules are molecules of a type typically found in a biological system, whether such molecule is naturally occurring or the result of some external disturbance of the system (e.g., a disease, poisoning, genetic manipulation, etc.), as well as synthetic analogs and derivatives thereof. Non-limiting examples of biomolecules include amino acids (naturally occurring or synthetic), peptides, polypeptides, glycosylated and unglycosylated proteins (e.g., polyclonal and monoclonal antibodies, receptors, interferons, enzymes, etc.), nucleosides, nucleotides, oligonucleotides (e.g., DNA, RNA, PNA oligos), polynucleotides (e.g., DNA, cDNA, RNA, etc.), carbohydrates, hormones, haptens, steroids, toxins, etc. Biomolecules can be isolated from natural sources, or they can be synthetic.

A “control” refers to a value that serves as a reference, usually a known reference, for comparison to a test reagent, assay, sample or set of conditions. For example, a test assay can include a sample exposed to a test condition or a test agent, while the control is not exposed to the test condition or agent (e.g., a primary antibody). The control can also be a positive control, e.g., a known assay exposed to known conditions or agents, for the sake of comparison to the test condition (e.g., a standard two-step immunoassay using a secondary antibody). A control can also represent an average value gathered from a plurality of samples, e.g., to obtain an average value. A control value can also be obtained from the same sample or batch of reagent, e.g., from an earlier-obtained sample or batch prior to storage. One of skill will recognize that controls can be designed for assessment of any number of parameters.

One of skill in the art will understand which controls are valuable in a given situation and be able to analyze data based on comparisons to control values. Controls are also valuable for determining the significance of data. For example, if values for a given parameter are widely variant in controls, variation in test samples will not be considered as significant.

### II. Embodiments

The present invention provides systems and methods which enable or utilize an immunologically-based assay, such as a Western immunoassay, to separate, detect or to monitor an analyte such as a biomolecule. The preferred method of the invention utilizes a sensitive Western immunoassay to separate and detect proteins. Advantageously, the systems, methods and kits can be used in sensitive diagnostic methods.

A. Systems and Methods

The present invention provides systems and methods for separating molecules such as biomolecules. In one embodiment, the present invention provides an electrophoresis system useful for a Western immunoassay, the electrophoresis system comprising:
a substrate comprising a plurality of colloidal nanoparticles;
a power supply for applying a voltage along the substrate; and
a means for applying a detection reagent.

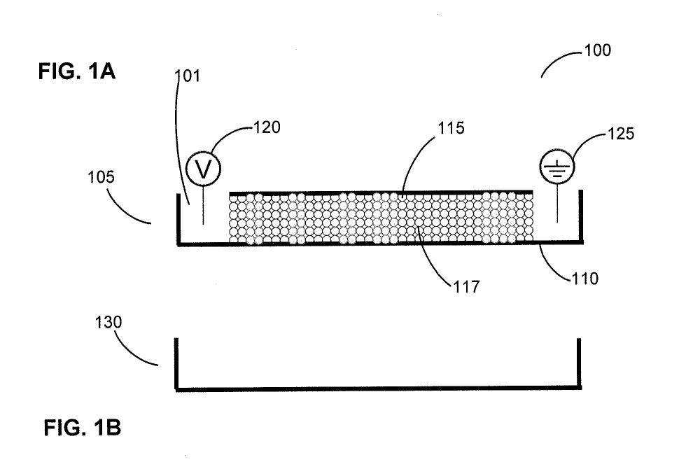

FIGS. 1A-B illustrate one embodiment 100 of an electrophoresis system of the present invention useful for an “in-crystal” Western immunoassay. In one aspect, a separation bed 115 having a plurality of particles 117 is disposed on a surface or substrate 110 of device 105. The substrate can be glass, plastic, metal, ceramic, or other inert surface. The separation bed 115 may or may not be enclosed with other surfaces. In one aspect, a sample 101, which can be a mixture of proteins or biological molecules, is placed into the device and an electric field between voltage terminals 120 and 125 is applied. Terminal 120 typically has a negative voltage and terminal 125 is grounded. The electrophoresis system of the present invention can then separate the mixture of analytes based on the charge of each of the molecules in the mixture. For example, the separation bed is used to separate proteins as a function of size, pI, or other useful characteristic using electrophoresis, pressure-driven flow, convection, or other flow mechanism. As the Western immunoassay is performed in a colloidal crystal (i.e., a separation bed) it can be known herein as an “in-crystal” Western immunoassay.

In certain aspects, the electrophoresis systems and methods of the present invention include nanoparticles 117 such as individual particles, wherein the nanoparticles are made of silica. In certain aspects, the silica nanoparticles are arranged in a regular, crystalline structure. In certain aspects, the crystal structure is body centered cubic. Each of the plurality of nanoparticles is between about 1 nm to about 2000 nm in diameter, more specifically between about 1 nm to 10, 20, 30, 40, 50, 60, 70, 80, 90, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, or 2000 nm in diameter. The population of nanoparticles can be monodisperse or polydisperse. Larger particles, with diameters on the order of a few microns (2, 3 or 4 μm), can also be used in the methods of the invention. In certain aspects, the colloidal silica nanoparticles are spheres having a diameter of about 1 μm, thereby resulting in a minimum interstitial space size (or pores) of about 155 nm and a surface-to-volume ratio of about 13. The pore size can range from 0.15 nm to 309 nm or more (see, Example 9).

In certain aspects, the present invention provides a pluality of colloidal nanoparticles which comprise substantially monodisperse colloidal nanoparticles, which gives rise to a monodisperse interstitial pore size. A monodisperse pore size increases the separation efficiency, giving increased separation resolution when samples are separated over the same distance. An increase in the separation efficiency leads to shorter separation lengths, increased resolution, or decreased separation times. In certain aspects, the colloidal nanoparticles are about 80, 81, 82, 83, 84, 85, 86, 87, 88, 89, 90, 91, 92, 93, 94, 95, 96, 97, 98, 99, or about 100% monodisperse.

In one aspect, the power for applying a voltage along the substrate between terminals 120 and 125 supplies an electric field having voltages of about 1 V cm⁻¹ to 2000 V cm⁻¹, such as about 1, 10, 20, 30, 40, 50, 60, 70, 80, 90, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, or about 2000V cm⁻¹. Higher voltages or varied voltages can also be used, depending on the particular separation methods employed.

In certain preferred aspects, the electrophoresis system of the present invention is used in performing a Western immunoassay and includes a means for applying a detection reagent. As is illustrated in FIG. 1B, the means can include for example, a trough 130 or a chamber for contacting, dipping or incubating the separation bed or cassette of nanoparticles. In one aspect, the separation bed can be removed from the substrate and placed into or disposed into the means for applying a detection reagent. In other aspects, the trough 130 is of a size that the substrate bed or array fits comfortably into for incubation. The detection reagent can be an antibody such as a primary or secondary antibody. In certain aspects, the means for applying a detection reagent to the substrate is a member selected from a trough, an incubator, a tub for contact, a vat, a chamber, a vessel, and the like. In one aspect, the means for applying the detection reagent is a spray nozzle or shower head above the separation bed.

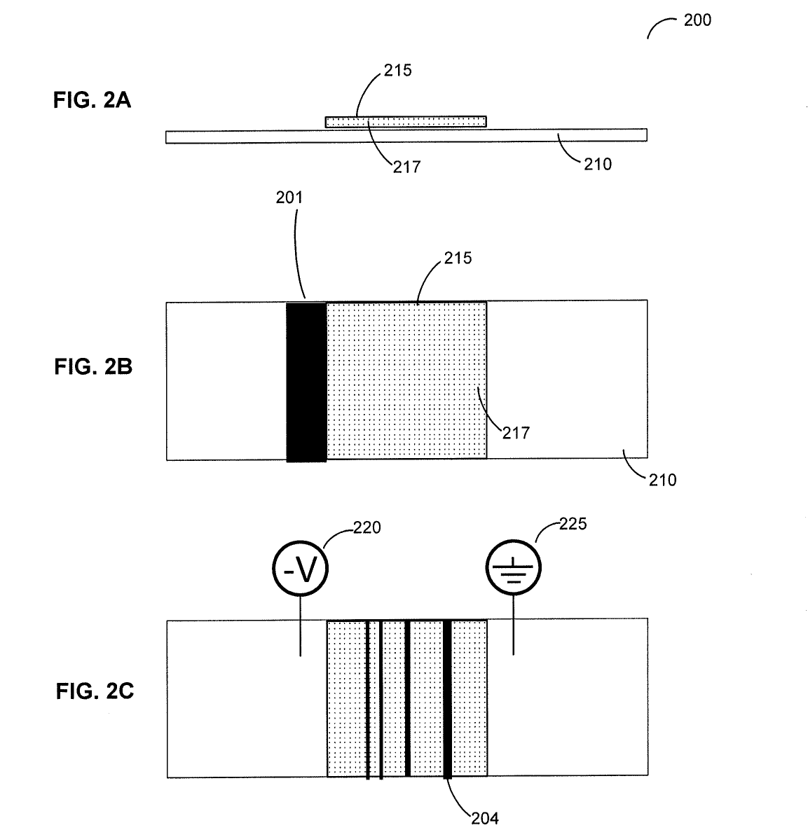

FIGS. 2A-C show additional views of an electrophoresis system of the present invention. FIG. 2A shows a side view of the separation bed 215 having a plurality of particles 217 disposed on the substrate 210. The top view in FIG. 2B shows that for example, a test sample 201 can be introduced from one side of the separation bed 215. The separation bed 215 has individual particles 217 to effectuate separation of a mixture of analytes (e.g., a mixture of biomolecules).

As shown in FIG. 2C, an electric field between voltage terminals 220 and 225 is applied so as to resolve a plurality of analytes or mixture of molecules in the sample into bands e.g., 204 along the electric field 220 to 225 on substrate 210. The bands can be removed from the separation bed (e.g., by eluting the sample) or remain in the separation bed and further analysis can be performed. In one instance, the molecular weight of the analyte can be determined.

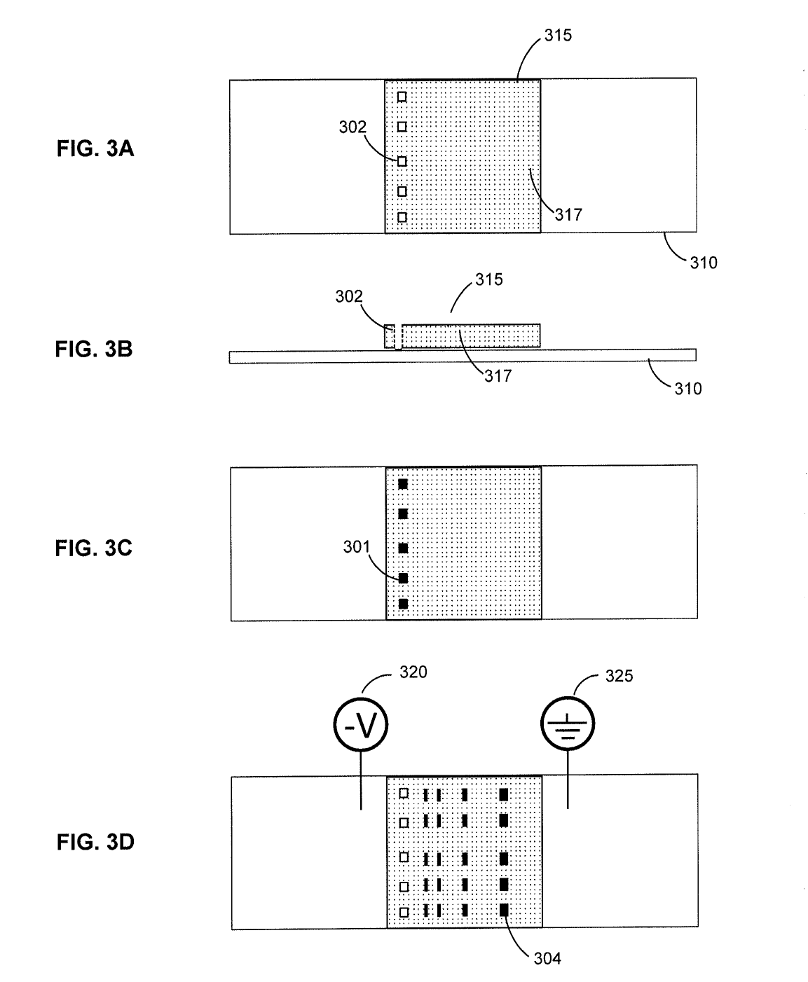

Turning now to FIGS. 3A-D, a shown therein is one embodiment of the an electrophoresis system of the present invention configured for parallel analysis of multiple samples. FIG. 3A shows a top view of the separation bed 315 having the plurality of particles 317 disposed on the substrate 310. The separation bed also contains a number of individual wells e.g., 302, wherein multiple individual samples (which can be the same or different) can be loaded for separation.

A cut-a-way side view is shown in FIG. 3B, and includes an arrangement of a well 302 in the separation bed 315 having the plurality of particles 317 disposed on the substrate 310.

Each individual well can be loaded with samples 301 (now darkened) as shown in FIG. 3C. Any number of wells can be loaded with the same or different samples. One sample can include a control, molecular weight protein ladder, and the like. Since the plurality of wells contain no silica particles, the sample will generally remain confined within the well for some amount of time. Further, once the electric field is applied, the samples ‘stack’ on the leading edge of the separation bed to improve separation or resolution.

As shown in FIG. 3D, an electric field between voltage terminals 320 and 325 is applied so as to resolve a plurality of analytes in the sample into individual bands e.g., 304. In the case of the samples shown in FIG. 3D, the 5 wells contained the same sample with four different analytes. Analyte 304 has the highest concentration in the mixture.

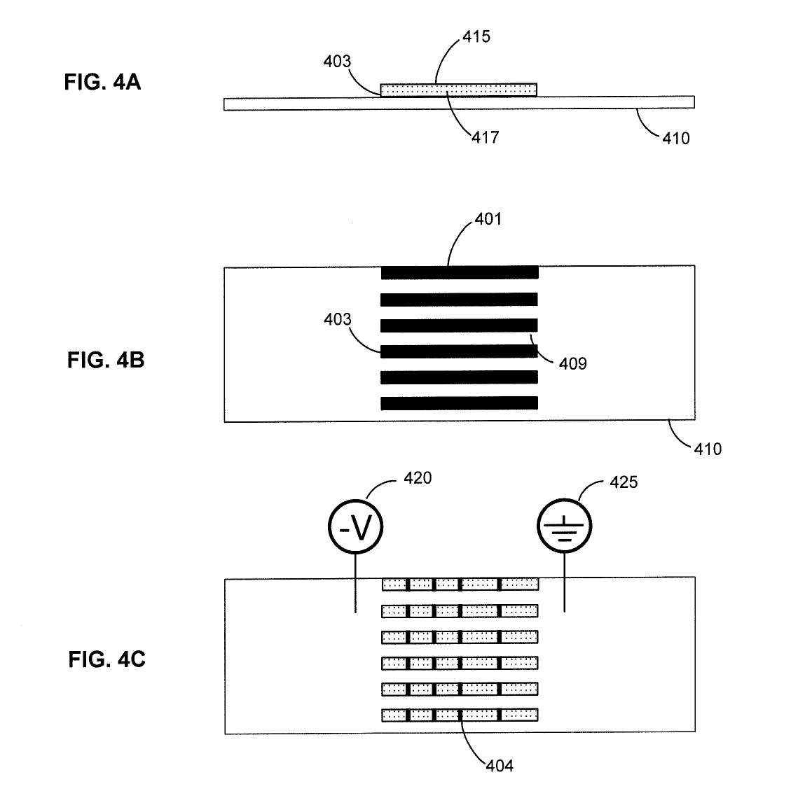

FIGS. 4A-C show another configuration for parallel analysis of multiple samples, which samples may be the same or different, using methods and systems of the present invention. FIG. 4A shows the separation bed 415 having a plurality of silica particles 417 is divided into a number of lanes e.g., 403.

As shown in FIG. 4B, a space between the lanes 409 can be a solid (e.g., part of a removable lid) or the space can be empty (i.e., dry, gaseous). The silica particles provide a strong capillary force. When a sample 401 of a certain volume is pipetted onto an individual lanes, the sample will remain within the lane. If for example, the separation method is isoelectric focusing (using pI), the samples do not have to be “stacked” at either end. As such, the lane configuration is convenient for keeping samples separate and in a distinct area while allowing one-dimensional (1D) separation.

FIG. 4C shows an experiment wherein six lanes are loaded with the same sample having four different analytes in the sample mixture. An electric field between voltage terminals 420 and 425 is applied so as to resolve the analytes in the sample into separate bands e.g., 404.

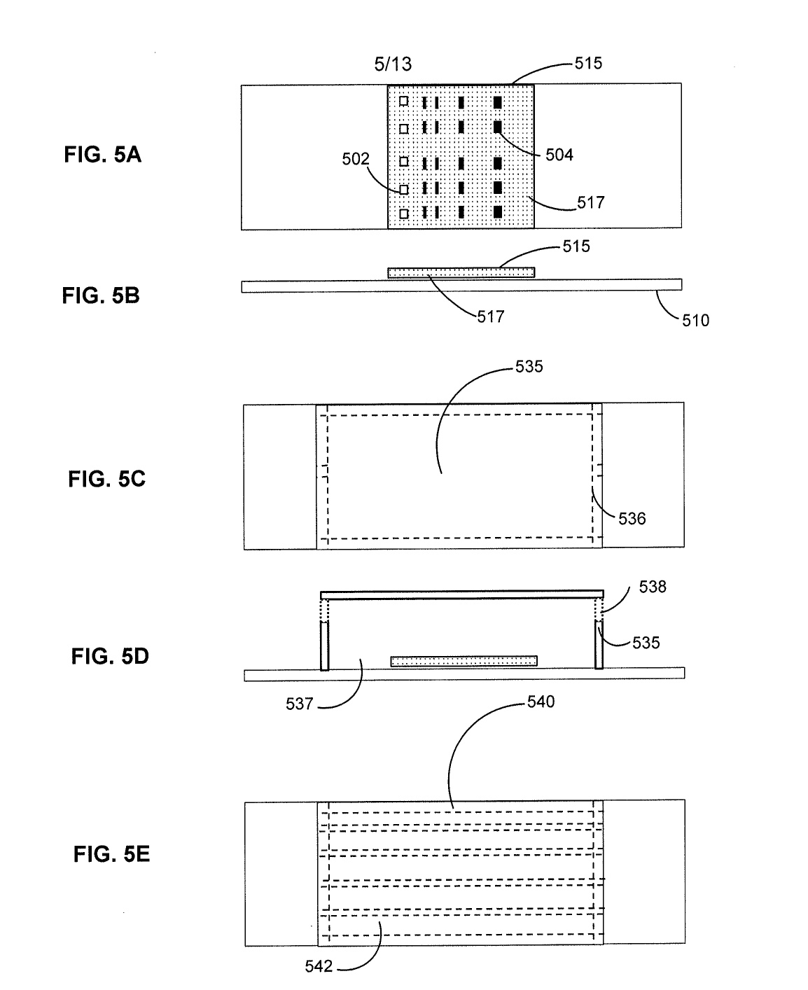

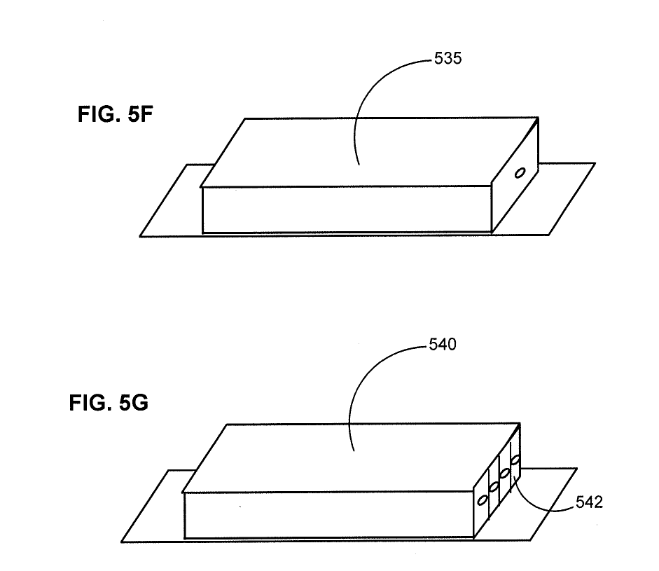

FIGS. 5A-G illustrate another aspect of the present invention. As shown in FIG. 5A, a mixture of analytes in a sample is resolved into individual bands e.g., 504. In the case of the samples shown in FIG. 5A, 5 individual wells contain the same sample with four different analytes within each sample. The separation bed 515 has a plurality of individual nanoparticles 517.

FIG. 5B shows the separation bed 515 having a plurality of silica particles 517 on a substrate 510.

FIG. 5C shows a manifold 535 having a gasket 536 aligned with the separation bed so as to form a chamber or vat into which a detection reagent can be introduced. The chamber formed by the manifold can cover the entire area of the separation bed.

FIG. 5D shows a side view (transparent) wherein manifold 535 aligns a strut 538 with a separation bed post 535 so as to form an internal chamber 537. The chamber 537 formed by the manifold can cover the entire area of the separation bed 515.

In an alternative embodiment as shown in FIG. 5E, a manifold 540 can form several individual chambers 542 into which the same or different detection reagents can be introduced independently. For example, the manifold can form a lane or chamber 542 covering an area containing resolved analytes from an individual sample. Multiple lanes 542 (dashed lines) can be arranged adjacent to each other for parallel analysis of multiple samples. The samples can be the same or different samples.

FIG. 5F shows a perspective view of manifold 535 with a single chamber.

FIG. 5G shows a perspective view of manifold 540 with multiple chambers or lane 542.

In one aspect, each of the nanoparticles with the separation bed is less than 2 μm (e.g., 1 μM or 1.5 μm) in diameter, and together they form a stationary phase for analytical separation. The nanoparticles are each preferably nonporous. In certain instances, larger nanoparticle sizes can result in a decrease in the ratio of surface to volume and an increase in the pore radius. This can decrease the selectivity and increase the migration speed of the analyte. In contrast, the smaller the nanoparticle size, the surface area to volume ratio increases and the pore radius decreases. This typically results in better or increased resolution.

In certain aspects, the population of nanoparticles are uncoated, coated, or a mixture of uncoated and coated. In certain aspects, the nanoparticles may be coated with either non-covalent coatings, covalent coatings or a combination thereof. In one aspect, a protein-free blocking buffer is used as a non-covalent coating for the nanoparticles (e.g., Pierce 37584 Protein-Free (PBS) Blocking Buffer). In certain aspects, buffers that supress or elimiate eletroosmotic flow (EOF) are used with uncoated nanoparticles (e.g., formic acid containing buffers).

In certain aspects, the nanoparticles are coated, such as with a polymer coat. The polymer modification can be a hydrophobic or a hydrophilic polymer. The nanoparticles can be a mixture of different types of coatings. Suitable hydrophilic polymers include, but are not limited to, polyalcohols, polyoxyethylenes, polyethers, polyamides, polyimides, polycarboxylates, polysulfates, polysufonates, polyphosphates, polyphosphonates and a combination thereof. In certain aspects, the polyamide hydrophilic polymer is a polyacrylamide.

In certain aspects, the polymer forms a brush layer on the plurality of nanoparticles. In one instance, the brush layer is a polyacrylamide. The bed of coated nanoparticles forms a matrix of silica particles ideal for separation.

In certain aspects, the hydrophilic polymer layer is further functionalized for immobilization of an analyte. In one aspect, the immobilization of the analyte is covalent. Alternatively, the immobilization is noncovalent. In certain aspects, the functionalization for immobilization of an analyte is effectuated by UV light, by a change in pH, or by precipitation. For example, proteins can be precipitated or fixed via an acid solution. Alternatively, proteins can be immobilized on separation bed via photoactivation of a benzophenone moiety which generates a highly reactive triplet intermediate to form a covalent bond. Further, a radical species can react with tyramide to amplify signals.

In another embodiment, the present invention provides an electrophoretic method, the method comprising:
resolving at least one analyte on a substrate comprising a plurality of colloidal nanoparticles;
immobilizing the at least one analyte on the substrate to form an immobilized at least one analyte; and
detecting the immobilized at least one analyte.

In certain embodiments, a colloidal crystal nanoparticle, such as a plurality of silica colloidal crystals are disposed on a surface or substrate of a device. In one aspect, a sample, which can be a mixture of proteins or biological molecules, is placed into the device and an electric field between terminals is applied. In one instance, the mixture of analytes to be separated is placed at the cathode end. In another aspect, the mixture of analytes to be separated is placed at the anode end. In certain other instances, the sample can be placed anywhere between the cathode and anode.

In certain aspects, a sample for analysis is loaded on the inventive device and the power supply is used to electrophoretically separate the sample. The electrophoresis system can then separate the mixture in a second dimension based on the charge and or size of each of the molecules in the mixture. The separation bed is used to separate proteins as a function of size, pI, or other useful characteristics of the analyte using electrophoresis, pressure-driven flow, convection, or other flow.

After the mixture is separated (either in 1-dimension, 2-dimensions or multiple dimensions), the analytes (such as proteins) are immobilized on the nanoparticles using for example, pH, light or precipitation. Advantageously, there is no need to transfer or blot the separated molecules to a membrane.

The colloidal crystal with immobilized molecules (e.g., proteins) is optionally washed and then contacted, incubated or submerged in an antibody solution (blocking buffer may or may not be necessary depending on the bead coating) or with antibodies by a means for applying a detection reagent. The antibodies are specific for the analyte to be detected. In certain instances, this antibody is the “first antibody.” The substrate is then washed with a low salt buffer to remove non-binding antibodies and proteins.

The washed substrate is then incubated with a “second antibody” or antibodies that recognize the first antibody. In certain instances, the second antibody has a reporter group attached for the visualization of the first antibody. The reporter that is attached to the second antibody can be either a chemical “tag” or an enzyme (such as alkaline phosphatase, horseradish peroxidase) that catalyzes a reaction that converts an added substrate to a product that is visualized.

In some aspects, the tag is a label such as a fluorophore. In some embodiments, the label is a cyanine dye, e.g., a near IR dye (e.g., IRDye® 680RD, IRDye® 800CW or IRDye® 680LT). In some aspects, the primary antibody and/or secondary antibody can be a mammalian IgG, e.g., from a human, mouse, rat, goat, rabbit, horse, guinea pig, sheep, hamster, swine, bovine, cat, dog, or monkey. In some embodiments, the antibody is selected from the group consisting of human IgG, human IgA, human IgE, human IgM, and human IgD. In some embodiments, the antibody is a polyclonal antibody.

In one aspect, the nanoparticles are coated with a non-specific protein immobilization moiety that is activated post-separation (e.g. UV-light), or electrolytes are introduced to initiate a pH-dependent reaction by electrophoresis or pressure, or the colloidal crystal is submerged in an electrolyte.

In one aspect, the colloidal crystal can enable multiple ‘lanes’ either as a single, continuous entity in which diffusion does not allow cross-reactivity between lanes, or the colloidal crystal can be printed as individual lanes with a barrier between (if necessary). After washing, the antigen and ladder may be detected in the separation bed by various means such as an optical means (e.g., fluorescence).

In certain aspects, a colloidal crystal structure is a densely ordered packing of particles in a patterned arrangement (e.g. face-centered cubic) with long range order that is generally hundreds of particles long, but may be more or less particles in length, and typically extends in two or three dimensions. A coloidal crystal is most often composed of spherically shaped particles, but may be composed of non-spherical particles as well (Langmuir 2007, 23, 8810-8814). A colloidal crystal may be composed of monodisperse particles or may also be composed of multiple particle sizes in an arrangement such that a predictable pattern is created. One of the most common techniques used to create colloidal crystals is Evaporative Induced Self-Assembly (EISA).

In certain aspects, the smaller the particle size the better separation of small proteins. For example, proteins of molecular weight 5-30 kDa are separated with nanoparticles having a diameter of 100 nm to 500 nm. In other aspects, proteins of molecular weight 30-100 kDa are separated with nanoparticles having a diameter of 500 nm to 700 nm. In still other aspects, proteins of molecular weight 100-500 kDa are separated with nanoparticles having a diameter of 700 nm to 1000 nm.

The method of visualization can include chemiluminescent, chemifluorescence, fluorescence, or colorimetric technologies. In one instance, a visualization method is chemiluminescent and based on a peroxidase (e.g., horseradish peroxidase) reporter conjugated to the second antibody or a fluorescent label.

In another aspect, the present invention provides for multiple dimension (such as 2-D or 3-D or more) separation. For example, in one embodiment, isoelectric focusing can be used in a first dimension, followed by a separation along a second dimension. Suitable second dimension separation techniques include, but are not limited to, capillary electrophoresis, thin layer chromatography, high pressure chromatography, size exclusion chromatography and the like.

In certain other aspects, the present invention provides various lanes for the analytes to be separated in one-dimension. The space between the lanes may either be a solid (e.g. part of the removable lid), or the space may be empty (i.e., dry, gaseous). The colloid crystals provide a strong capillary force, therefore, if one pipetted samples onto the individual lanes (of certain volumes) the sample remains within a given lane. If the separation method is IEF, the samples do not have to be ‘stacked’ at either end, therefore, the lane configuration is convenient for keeping samples separate and distinct, while allowing 1-D separation.

In certain aspects, the electrophoresis system of the present invention has a substrate comprising an x-axis and a y-axis and a voltage is configured to resolve or separate an analyte along the x-axis as a first dimension. In one aspect, the system is configured to separate or resolve an analyte along the y-axis as a second dimension. In one aspect, the resolution or separation is performed using the size of the analyte. Separations in multiple dimensions are possible.

In certain aspects, the electrophoresis systems and methods of the present invention resolve or separate the analyte as a function of the pI of the analyte. The isoelectric point (pI) is the pH at which a particular molecule carries no net electrical charge. Other suitable techniques for resolution or separation include, but are not limited to, electrophoresis, isoelectric focusing, and chromatography.

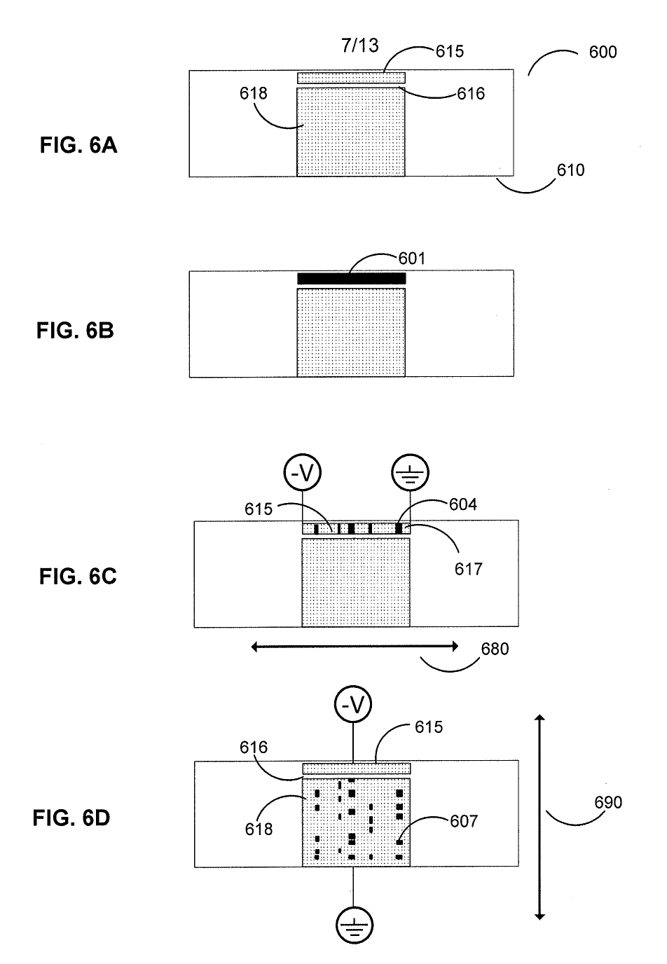

Turning now to FIGS. 6A-D, a 2-D separation device 600 is shown. For example, in FIG. 6A the device 600 is on substrate 610. A separation bed or lane 615 can be used to resolve or separate a sample mixture into individual analytes. A gap 616 between a separation bed 615 and separation bed 618 can be filled with a buffer or other suitable solution to enable migration of the resolved analytes from the first separation bed of the first dimension to migrate to the second separation bed of the second dimension.

In one aspect, as shown in FIG. 6B, lane 615 is loaded with sample 601 prior to separation in the first dimension using the first separation bed or lane.

In FIG. 6C, the sample is resolved along a longitudinal direction 680 (x-axis) in a separation bed 615 having a plurality of silica particles 617 so as to form one or more resolved analytes e.g., 604. In this example, an electric field is used to separate a mixture into 5 separate analytes in the first dimension. An electric field is applied along a longitudinal direction 680 (x-axis), wherein the sample is separated.

In FIG. 6D, as a non-limiting example, after isoelectric focusing is used in the longitudinal dimension 680 (x-axis), another separation is used in a second dimension such as a latitudinal dimension 690 (y-axis) to form one or more analytes 607 resolved in two dimensions (2-D separation). The separation in the second dimension can be conducted in a second separation bed 618. Again, the gap 616 between the separation beds 615 and 618 can be filled with a suitable solution to enable migration of the resolved analytes from the first separation bed to the second separation bed. An electric field can be applied in the second dimension. In this instance, the electric field is applied along a longitudinal direction 690 (y-axis).

Suitable second dimension separation techniques include, but are not limited to, capillary electrophoresis, thin layer chromatography, high pressure chromatography, size exclusion chromatography and the like.

Resolved analytes can also be visualized in the separation bed. In certain aspects, proteins can be labeled with a dye (such as a fluorescent dye) before or after separation. Examples of suitable dyes include, but are not limited to, rhodamines, fluoresceins, coumarins, and cyanines. In certain aspects, a cyanine dye can be a near IR dye (e.g., IRDye® 680RD, IRDye® 800CW or IRDye® 680LT). Alternatively, resolved analytes can be detected using antibodies or combinations of antibodies that are specific for analytes of interest. In some aspects, a primary antibody and/or a secondary antibody can be a mammalian IgG, e.g., from a human, mouse, rat, goat, rabbit, horse, guinea pig, sheep, hamster, swine, bovine, cat, dog, or monkey. The antibody can be, for example, human IgG, human IgA, human IgE, human IgM, and human IgD. The antibody can be a monoclonal antibody or a polyclonal antibody. Labeled analytes and labeled analyte/antibody conjugates can be detected, for example, with a fluorescence scanner. Depending on the detection strategy, visualization of resolved analytes can also include chemiluminescent and colorimetric methods as is known in the art. For example, resolved analytes can be visualized using a horseradish peroxidase (HRP) reporter conjugated to an antibody and subjecting the enzyme with a substrate to produce a product with an emission of light. Chemiluminescent substrates for horseradish peroxidase (HRP) are typically two-component systems consisting of a peroxide solution and an enhanced luminol solution. After mixing the two components together and incubating with HRP-conjugated antibodies, a chemical reaction produces light.

B. Kits

The present invention further provides kits for convenient immunoassays such as Western immunoassays. The kit contains a substrate with nanoparticles useful for carrying-out a Western immunoassay. In some aspects, the kit comprises tubes for detection reagents. In some aspects, the detection reagents are lyophilized, and a container with solution for reconstitution is provided in the kit. In other embodiments, the kit includes wash or blocking buffers compatible with the substrate. In still other embodiments, the kits contain protein ladders or mixtures of highly purified proteins, which resolve into clearly identifiable sharp bands. The sizes can range from 5-500 kDa or more. The protein ladder is intended for use as a precise size standard when performing electrophoresis to calculate the molecular weight of a protein of interest.

Kits according to the invention typically include instructions for use. For example, in a simple embodiment of the antibody labeling solution, the instructions can recite the protocol for adding a desired antibody to the analyte to be detected.

The diagnostic kits and immunoassays described herein can be used to diagnosis diseases or disorders such as, but not limited to, Lyme disease, other tick-borne disease, Creutzfeldt-Jakob Disease, prion disease, HIV infection, HSV infection, HCMV infection, SARS infection, Helicobacter pylori infection, Campylobacter pylori infection, Parvovirus infection, Hepatitis C infection, Kaposi's sarcoma virus infection, influenza infection, other viral infections, bacterial infection, Staphylococcus aureus infection, fungal infection, paraneuplastic syndrome, amyotophic lateral sclerosis (ALS), spinal muscular atrophies (SMA), primary lateral sclerosis (PLS), Arthrogryposis Multiplex Congenita (AMC), Alzheimer's disease, heart failure severity, lung cancer, pancreatic cancer, colorectal cancer, prostate cancer, bladder cancer, gastric cancer, oral cancer, breast cancer, ovarian cancer, lymphoma, metastasis, neoplasia, COPD, kidney disase, Sjogren's syndrome, autism, depression, neuropsychiatric disease, inflammatory disease, autoimmune disease, myasthenia gravis, scleroderma, osteoporosis, and the like. Detailed descriptions of diagnostic method based on western blotting are found in, e.g., U.S. Pat. Nos. 8,962,257; 8,145,112; 8,257,917; 7,709,208; 7,192,698; 6,013,460; and 5,545,534.

Controls can also be included, e.g., containers with labeled proteins and known antibody and antibody targets to run alongside the desired sample. Controls can also include known antibodies and/or antibody targets at preset concentrations, e.g., for titering a desired assay.

A kit can also include a plurality of containers with labeled antibodies such as with different labels that are detected in different conditions (e.g., different fluorophores or enzymes. The plurality of containers can also include antibodies with different amounts of covalently attached label, e.g., for detection of relatively abundant vs. rare targets.

A kit according to the invention can include a panel of known antibodies, e.g., for detection of certain conditions. For example, a colorectal cancer-specific detection kit can include antibodies to known CRC markers. The kit can also include positive and negative target controls.

In some embodiments, the kit includes assay components, e.g., for running an ELISA, or Western immunoassay. Thus, for example, a Western immunoassay kit can include solutions and reagents for carrying out the immunoassay. In some embodiments, the Western immunoassay kit can include containers with antibodies, optionally with positive and negative control samples. In some embodiments, the user will provide the desired test sample and the target-specific antibody to be labeled according to the invention.

In some embodiments, chemiluminescent reagents can be used. For Western blot detection methods, chemiluminescence is a preferred the detection method. Suitable reagents include luminol-based chemiluminescent substrates. Chemiluminescent substrates for horseradish peroxidase (HRP) are two-component systems consisting of a stable peroxide solution and an enhanced luminol solution. To make a working solution, the two components are mixed together and incubated with a blot on which HRP-conjugated antibodies (or other probes) are bound, in the presence of HRP, a chemical reaction produces light that can be detected by film or detector.

In some embodiments, the kit also includes components for immunoprecipitation, e.g., beads or other matrix associated with a capture agent. For example, the matrix can be coated with a substance that has affinity for antibodies or for a particular tag (e.g., Ni resin, strepavidin, etc.), or for proteins or nucleotides generally.

### III. Examples

### Example 1

### Preparation of the Nanoparticles

Silica nanoparticles having an approximate diameter of 250 nm, 500 nm, or 750 nm were purchased from Fiber Optic Center, Inc. (New Bedford, Mass.), and were then calcined at 600° C. for 12 h. Glass or quartz microscope slides were purchased. The silica nanoparticles were deposited onto the glass microscope slides using a draw-down coater, forming a highly-ordered three-dimensional silica colloidal crystal. The nanoparticles were then coated with a brushed layer of polyacrylamide.

### Example 2

### Detection of Rabbit IgG by in-Crystal Western Immunoassay

A Western immunoassay is compared to that of a traditional two-step detection using IRDye® 680LT labeled secondary antibodies.

In a traditional Western blot, serial dilutions of rabbit IgG are added to a C32 cell lysate. The lysate components are separated by SDS-PAGE and immobilized on membranes. The blots are probed with (1) mouse anti-rabbit IgG primary antibody followed by (2) IRDye® 680LT labeled goat anti-mouse secondary antibody (Control).

In the Western immunoassay, a C32 cell lysate is separated on a silica colloidal crystal and immobilized by precipitation. The crystals are probed with (1) mouse anti-rabbit IgG primary antibody followed by (2) IRDye® 680LT labeled goat anti-mouse secondary antibody (test sample).

The results indicate that the limit of detection (LOD) for the in-crystal Western immunoassay is comparable to a traditional Western blot.

### Example 3

### Summary of Differences of Conventional Methods and the Inventive Methods

| Protocol | | | | Direct-blotting | In-crystal western |
|---|---|---|---|---|---|
| Comparison | Western blot | In-gel western blot | Capillary Western | western | Inventive |
| 1. Sample | SDS-PAGE | SDS-PAGE | SDS-CE (sieving | SDS-CE (sieving | SDS-SCE (silica |
| separation | (polyacrylamide gel) | (polyacrylamide gel) | solution in capillary) | solution in | colloidal crystal) |
| | | | | microchannel/capillary) | |
| 2. Separation - | Crack open gel | N/A | N/A | Proteins migrate off | N/A |
| blotting | cassette, manually | | | end of separation | |
| connection | transfer gel to | | | channel with sheath | |
| | blotting sandwich | | | flow onto moving | |
| | with membrane | | | membrane | |
| 3. Blotting | Proteins transferred , | Proteins precipitated - | Proteins | Proteins transferred to | Proteins |
| | to membrane via | in gel (fixed) via | immobilized on | membrane via | immobilized on |
| | electrophoresis | acid solution | separation channel | electrophoresis and | silica surfaces via |
| | | | wall via UV- | sheath flow | activateable (UV, |
| | | | aetivated, non- | | pH, etc.), non- |
| | | | specific, covalent | | specific, covalent |
| | | | bond | | bond, optionally |
| | | | (benzophenone) | | remove ‘cassette’ (or |
| | | | | | optionally |
| | | | | | immobilization by |
| | | | | | precipitation) |
| 4. Blocking | Membrane soaked in | N/A | Capillary filled with | Membrane soaked in | Crystal soaked in |
| | blocking buffer | | blocking buffer | blocking buffer | blocking buffer, or, |
| | | | | | N/A |
| 5. Probing | Membrane soaked in | Gel soaked in | Capillary filled with | Membrane soaked in | Crystal soaked or |
| | antibody solution | antibody solution | antibody solution | antibody solution | incubated in |
| | | | | | antibody solution |
| 6. Detection | Membrane imaged | Gel imaged | Capillary scanned | Membrane imaged | Crystal imaged |
| | (chemiluminescence, | (chemiluminescence, | (chemiluminescence, | (chemiluminescence, | (chemiluminescence, |
| | fluorescence, stain, | fluorescence, stain, | line sensor) | fluorescence, stain, | fluorescence, stain, |
| | densitometry, etc.) | etc) | | densitometry, etc.) | or SPR) |

### Example 4

### One-Dimensional Separation and Western Analysis of a Protein Mixture

A glass slide is chemically modified with a solution of n-butyldimethylchlorosilane in anhydrous toluene under nitrogen. The slide is then rinsed with dry toluene and dried under vacuum at 80° C. A 1-mm-wide stripe of 1 cm in length is masked off on the slide and chemically etched with an ammonium bifluoride salt paste. A second, chemically modified glass slide is used to cover the channel, and the assembly is secured using binder clips. A 10% w/w silica colloid is wicked into the channel and allowed to dry at room temperature. After drying, the cover glass slide is removed and the packed channel is silylated with a polymerization initiator. Linear polyacrylamide chains are grown using a complex of CuCl with tris(2-dimethylaminoethyl) amine as the catalyst; the slide is immersed in a solution of acrylamide monomer and CuCl catalyst and the mixture is allowed to polymerize.

The slide with the packed channel is wetted with running buffer (25 mM Tris; 192 mM glycine; 0.1% (w/v) SDS; pH 8.0) and covered with a PDMS seal at each end of the channel to prevent drying. The channel is electrically conditioned at 50 Vcm⁻¹ using a high-voltage power supply until the current becomes static.

Proteins (rabbit IgG, myoglobin from equine skeletal muscle, cytochrome c from bovine heart and lysozyme from chicken egg white) are dissolved in PBS buffer and combined in a denaturation buffer (62 mM Tris; 1 mM EDTA; 3% sucrose; 2% SDS; pH 8.0). The concentration of each protein is about 0.05 mg/mL. The proteins are denatured at 100° C. for 3 minutes.

Proteins are electrokinetically loaded into the prepared channel under 300 Vcm⁻¹ for 30 s. Next, the channel is mounted between buffer-filled reservoirs and an electric field of 50 Vcm⁻¹ is used for separation. Following separation, the channel is briefly rinsed in deionized water, and the resolved proteins are fixed in the polyacrylamide brush layer using a mixture of methanol, deionized water, and acetic acid (50:45:5, v:v:v). The crystals are probed with antibodies to detect the resolved proteins. The rabbit IgG is detected by probing with (1) mouse anti-rabbit IgG primary antibody, followed by (2) IRDye® 680LT labeled goat anti-mouse secondary antibody. The myoglobin is detected by probing with (1) mouse anti-myoglobin IgG primary antibody, followed by (2) IRDye® 800CW labeled goat anti-mouse secondary antibody. 0.1% Tween-20 is included in the primary antibody solution. The crystal is briefly washed with PBS containing 0.1% Tween-20 before applying the secondary antibody solution. The secondary antibody solution contains 5% w/v non-fat milk. The crystal is washed briefly with PBS before imaging using an IR scanner.

### Example 5

### Two-Dimensional Separation and Western Analysis of a Protein Mixture

A pH gradient is established across a channel packed with a silica colloidal crystal (fabricated as described above) using a commercially available carrier ampholyte mixture

Proteins (rabbit IgG, myoglobin from equine skeletal muscle, cytochrome c from bovine heart and lysozyme from chicken egg white) are dissolved in PBS and combined in an isoelectric focusing solution (8 M urea; 20 mM DTT; 0.5% Triton X-100). The concentration of each protein is about 0.05 mg/mL.

Proteins are electrokinetically loaded into the prepared channel under 300 Vcm⁻¹ for 30 s. Isoelectric focusing is conducted by ramping the voltage from 50 Vcm⁻¹ to 1000 Vcm⁻¹ over a period of time sufficient for separation of the proteins.

The channel is aligned with a second channel equilibrated with SDS running buffer (25 mM Tris; 192 mM glycine; 0.1% (w/v) SDS; pH 8.0). A voltage of 50 Vcm⁻¹ is applied across the aligned channels to separate the proteins according to size. Following separation, the channel is briefly rinsed in deionized water, and the resolved proteins are fixed in the polyacrylamide brush layer using a mixture of methanol, deionized water, and acetic acid (50:45:5, v:v:v). The crystals are probed with antibodies to detect the resolved proteins. The rabbit IgG is detected by probing with (1) mouse anti-rabbit IgG primary antibody, followed by (2) IRDye® 680LT labeled goat anti-mouse secondary antibody. The myoglobin is detected by probing with (1) mouse anti-myoglobin IgG primary antibody, followed by (2) IRDye® 800CW labeled goat anti-mouse secondary antibody. 0.1% Tween-20 is included in the primary antibody solution. The crystal is briefly washed with PBS containing 0.1% Tween-20 before applying the secondary antibody solution. The secondary antibody solution contains 5% w/v non-fat milk. The crystal is washed briefly with PBS before imaging using an IR scanner.

### Example 6

### Non-Covalent Binding of Protein to Polyacrylamide Coated Silica Colloidal Crystal Surface

An automatic drawdown machine was used to coat a clean glass slide with an approximately 30% silica colloid slurry in ethanol. The silica slurry was allowed to dry on the glass slide. Silica coated glass slides were placed face up in a covered glass Petri dish in a fume hood. The glass slides were flushed with Argon for several minutes. Using a syringe and needle, a total of 100 μL silicon tetrachloride (SiCl₄) was placed on the bottom of the dish in several locations and the dish was flushed with argon for one minute. Vapor deposition of the SiCl₄ was allowed to take place for 5 minutes. After the vapor deposition was complete, the process was repeated for additional time to ensure sufficient deposition of the SiCl₄.

Silica coated slides were placed in a beaker with 1M nitric ccid. The 1M nitric acid was heated to reflux for 1 hour. The 1M nitric acid was decanted and the slides were washed with Milli-Q water followed by an ethanol wash. The slides were dried at 60° C. for 24 hours. Re-hydroxylated silica coated slides were washed with toluene followed by a 30 minute exposure to a solution of 2% ((chloromethyl)phenyl)trichlorosilane and 0.1% methyltrichlorosilane in toluene. The slides were then washed with toluene and dried at 120° C. for 3 hours.

Re-hydroxylated and silanized silica coated slides were washed with water: 2-propanol (1:1) followed by a 3 hour exposure (under argon gas) to a solution of 0.5M acrylamide, 10 mM copper chloride, 10 mM Tris[2-(dimethylamino)ethyl]amine and 8 mM L-ascorbate in water: 2-propanol (1:1). The slides were washed with water: 2-propanol (1:1) and then dried at 120° C. for 3 hours.

To test protein binding on the silica coated slide surface with the addition of a protein precipitation solution, 1 μl of a 10 ng/μl IRDye® 680LT Goat anti-mouse IgG solution was spotted onto the silica coated slide. The slide was imaged using a LI-COR Odyssey® Imaging System and the image was recorded. The slide was then either incubated in 40% methanol with 10% trichloroacetic acid (TCA) for 1 hour, or left untreated. The treated slides were rescanned on the Odyssey® Imaging-System. The slides were then placed in Odyssey® Blocking Buffer for 1 hour, washed with a PBS solution and rescanned on the Odyssey® Imaging System. The slides were then incubated for 1 hour in a IRDye® 800CW Donkey anti-goat IgG solution. The slides were washed for 30 minutes in PBS and the 800 nm channel was imaged on the Odyssey® Imaging System to identify binding of the IRDye® 800CW Donkey anti-goat IgG.

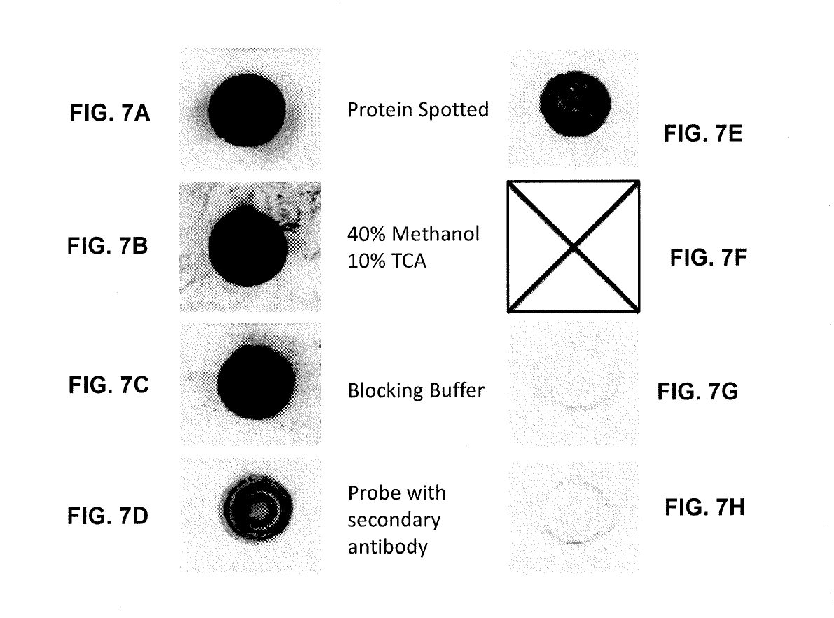

FIG. 7 A-7D show that protein spots incubated with the protein precipitation solution (40% methanol and 10% TCA), were mainly retained on the silica coated slides. FIG. 7E-7H show protein spots that were not incubated with the protein precipitation solution were mostly removed during the subsequent incubation and washing steps.

### Example 7

### Protein Separation in a Microchannel Through a Polyacrylamide Coated Silica Colloidal Crystal by Isoelectric Point

A 1.8-cm long channel was packed with silica particles that were coated with a polyacrylamide brush layer. The ends of the channel were fitted with reservoirs that could be used for loading the channel and for electrophoresis. A platinum electrode was inserted into each reservoir and connected to a power supply. The channel was imaged by placing the chip on an inverted fluorescence microscope, and using fluorescence-labeled proteins in the experiments.

4% Carrier ampholytes pH 3-10, 8 M urea, 2% CHAPS and 50 mM dithiothreitol was applied to the whole channel, along with a mixture of carbonic anhydrase I and II and lectin glycoprotein, all of which were labeled with Alexa Fluor 546. The catholyte reservoir was filled with 20 mM NaOH and the analyte reservoir was filled with 20 mM H₃PO₄. The electric field was supplied by a high-voltage power supply to produce approximately 100V/cm. The proteins were allowed to migrate to their isoelectric points and the channel was imaged with an inverted optical microscope equipped with an excitation source and filter set suitable to image the 546 nm labeled proteins. The channel was opened so that one surface of the entire length of the channel was accessible.

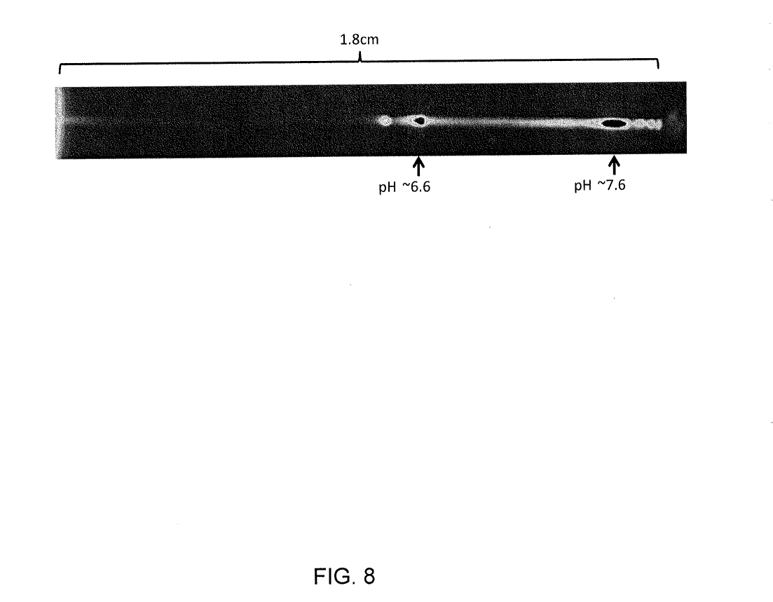

FIG. 8 shows IEF separation of labeled carbonic anhydrase I and II (pI=6.6) and lectin glycoprotein (pI=7.6) in a 1.8 cm long microchannel that is packed with polyacrylamide coated silica beads.

### Example 8

### Protein Separation by Size in a Capillary Packed with a Silica Colloidal Crystal

Silica particles were calcined at 600° C. three times for 6 h each in a box furnace, then rehydroxylated in 50% nitric acid, and finally suspended in ultrapure water and used to make a 30% (w/w) slurry. Fused silica capillaries of 100 μm i.d. with Teflon coatings were cleaned by pumping 0.1 M NaOH for 15 min, then rinsed with ultrapure water and ethanol for 20 min each, and then cut into 12 cm sections and dried in a vacuum oven at 70° for 30 min.

Silica slurries were prepared at a 30% w/w concentration in water and sonicated in a water bath. Slurries were wicked into capillaries of 12 cm in length, and then packed under pressure at 345 bar with sonication for 15 min using a 0.5 μm frit. After packing, the fit was removed and the capillary was allowed to dry in a dessicator.

PDMS buffer reservoirs were placed on a glass slide to prevent electrophoresis gas bubbles from entering the channel. The packed capillaries packed were saturated with a buffer containing H₂O with 0.1% Formic acid and 0.1% SDS overnight. Protein samples labeled with a 546 nm fluorescent probe were and loaded into the capillaries by diffusion. The capillary was then mounted between the dual PDMS reservoirs in a tight-fitting notch, with the protein loaded at the cathode end. Platinum electrodes were placed in the outer reservoir wells. The reservoirs were then filled with sample running buffer, and an electric field of 100 Vcm-1 was applied. The total separation length of the packed capillary was approximately 3.8 cm.

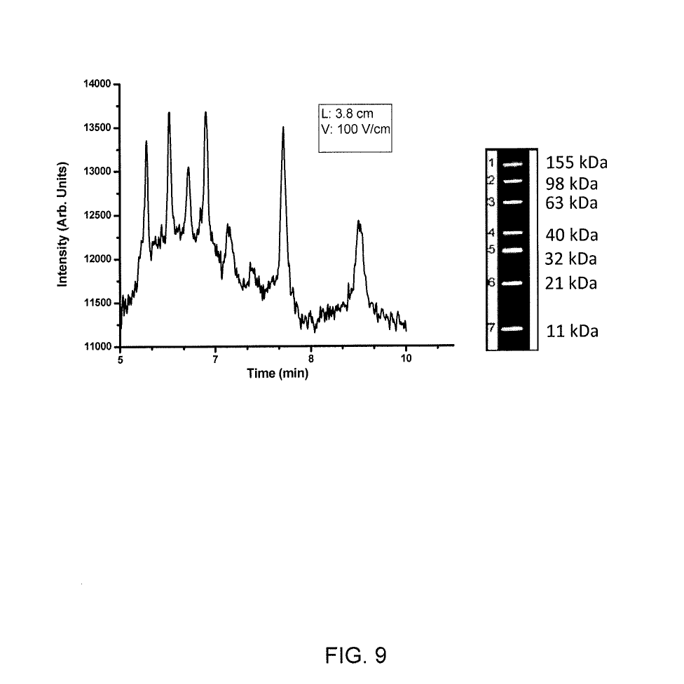

The proteins were allowed to migrate through the packed capillary and separate according to size. The labeled proteins were imaged at one end of the capillary with an inverted optical microscope equipped with an excitation source and filter set suitable to image the 546 nm labeled proteins (see, FIG. 9).

### Example 9

### Preparation of the Nanoparticles

Silica nanoparticles having an approximate diameter of 250 nm, 500 nm, or 750 nm were purchased from Fiber Optic Center, Inc. (New Bedford, Mass.), and were then calcined at 600° C. for 12 hours. Glass or quartz microscope slides were purchased. The silica nanoparticles were deposited onto the glass microscope slides using a draw-down coater, forming a highly-ordered three-dimensional silica colloidal crystal. The nanoparticles were then coated with a brushed layer of polyacrylamide.

The nanoparticles themselves are mostly the same diameters (monodisperse). Variance in the diameters is relatively low, such as less than ±25%, 20%, 15%, 10%, 9%, 8%, 7%, 6%, 5%, 4%, 3%, 2%, 1%, 0.5%, 0.25%, 0.1%, 0.01%, and other values.

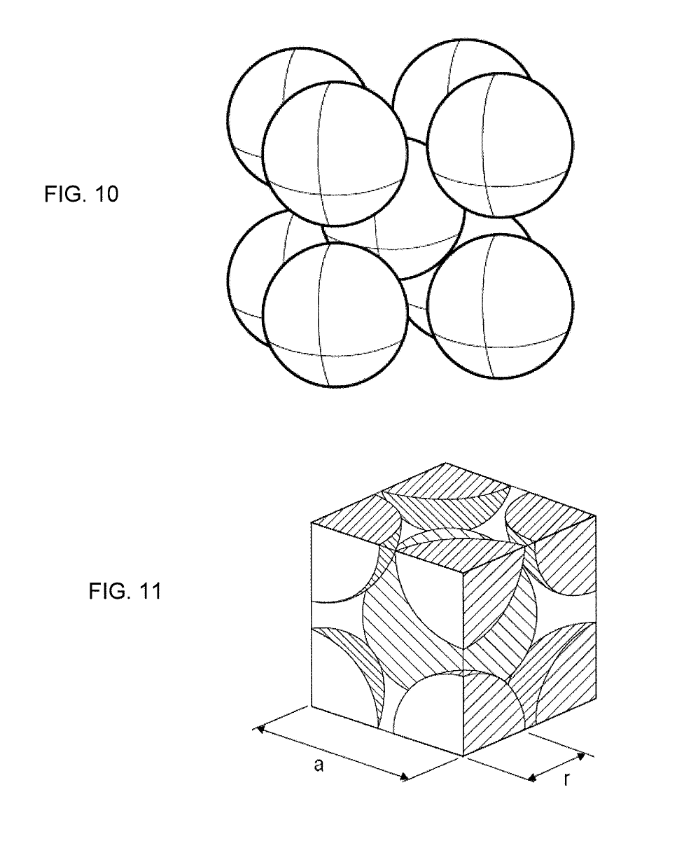

FIG. 10 illustrates spheres in a body centered cubic (BCC) configuration in accordance with an embodiment. FIG. 11 illustrates one unit cell of spheres in a body centered cubic configuration in accordance with an embodiment. Although all of the spheres do not form a body centered cubic configuration, it can be a good approximation for some portions of the resulting structure.

If each sphere has a radius ‘r’, then the length ‘a’ (see FIG. 11) of each edge of the unit cell is:

$$a = \frac{4}{\sqrt{3}} r \qquad Eqn . ( 1 )$$

The minimum pore size between the spheres is:

$${d}_{pore , min} = \frac{4}{\sqrt{3}} r - 2 r \qquad Eqn . ( 2 )$$

The volume of interstitial space in each unit cell is:

$${V}_{interstitial} = {V}_{unit cell} - {V}_{bead} = {( \frac{4}{\sqrt{3}} r )}^{3} - 2 \cdot \frac{4}{3} \cdot π {r}^{3} \qquad Eqn . ( 3 )$$

The ratio of interstitial volume to unit cell is a constant 47.0% for all sizes of bead particles.

The wettable surface area within each unit cell is:

2·4πr² Eqn. (4)

A table of some of these values with respect to particle diameter is provided below.

TABLE 1

| | | Unit Cell | | | Square |
|---|---|---|---|---|---|
| Particle | | Edge | | # of | meters of |
| Diameter | Radius r | Length a | Pore Size | particles in | surface area |
| (nm) | (nm) | (nm) | (nm) | 1 cm³ | in 1 cm³ |
| 1 | 0.5 | 1.15 | 0.15 | 1.3 × 10²¹ | 4,081 |
| 10 | 5.0 | 11.5 | 1.54 | 1.3 × 10¹⁸ | 408 |
| 100 | 50 | 115 | 15.4 | 1.3 × 10¹⁵ | 40.8 |
| 250 | 125 | 289 | 38.6 | 8 × 10¹³ | 16.3 |
| 300 | 150 | 346 | 46.4 | 5 × 10¹³ | 13.6 |
| 500 | 250 | 577 | 77.3 | 1 × 10¹³ | 8.16 |
| 750 | 375 | 866 | 116 | 3 × 10¹² | 5.44 |
| 1000 | 500 | 1155 | 155 | 1.3 × 10¹² | 4.08 |
| 2000 | 1000 | 2309 | 309 | 1.6 × 10¹¹ | 2.04 |

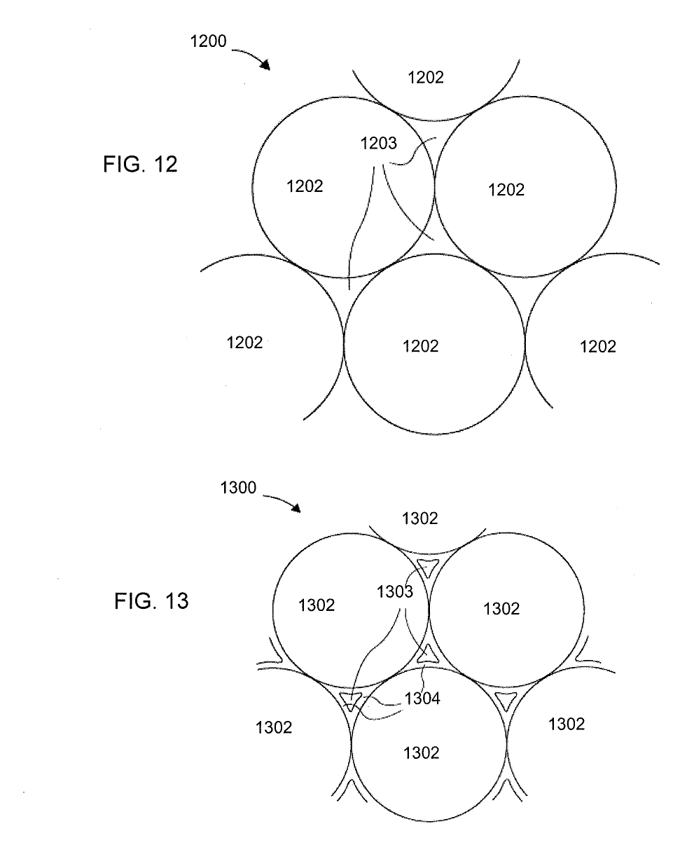

FIG. 12 illustrates a cross section of bare, uncoated packed nanoparticle spheres in accordance with an embodiment. In engineered structure 1200, silica spheres 1202 mate closely with one another when packed, forming small interstitial voids 1203 between them. The size of the voids, sometimes referred to as the pore size, can determine the absolute size of molecules that can funnel through the structure. Further, the size of the voids can determine the speed that certain molecules can squeeze through the structure.

Different packing configurations, such as body centered cubic (BCC), face centered cubic (FCC), hexagonal close packed, etc. can form in various parts of the silica colloidal crystal. Imperfections and voids can result in microcracks in some areas of the structure.

FIG. 13 illustrates a cross section of packed silica nanoparticles with a post-packing coating in accordance with an embodiment. After packing nanoparticles 1302 together, the resulting engineered structure 1300 is brush coated with a thin polymer, such as polyacrylamide, that seeps into interstitial spaces 1303. The thin liquid coats the spheres with film 1304, filling in a portion of the interstitial spaces. This causes the interstitial spaces to be smaller than they once were.

The polymer may be activated in order to immobilize certain analytes. This activation can be triggered by using electromagnetic radiation, such as ultraviolet light, infrared light, or visible light.

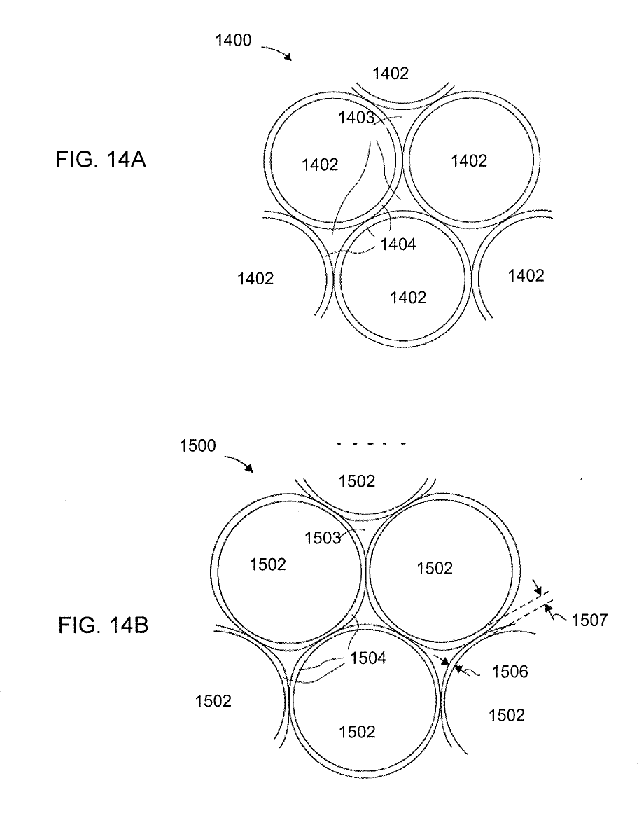

FIG. 14A illustrates a cross section of packed spheres with a hard pre-packing coating in accordance with an embodiment. Before the particles are packed together, they are coated with thin polyacrylamide layer that hardens into a relatively even incompressible shell 1404. As shown, the particles are effectively a little larger in diameter than uncoated nanoparticles 1402. The particles are then packed together into engineered structure 1400 and self-assemble, leaving regular interstitial spaces 1403.

FIG. 14B illustrates a cross section of packed spheres with a compressible pre-packing coating in accordance with an embodiment. Before nanoparticles 1502 are packed together, they are coated with a thin layer that hardens into a relatively even shell 1504. However, the shell is slightly resilient. As shown, the shells compress when the particles are packed together into engineered structure 1500, lessening the size interstitial spaces 1503.

The shells have an uncompressed thickness 1506. Thus, the distance between the silica core of the particles when the shells are uncompressed is 2 times thickness 1506. However, the compression in packing the particles together results in a distance 1507 between the silica core of the particles. Interstitial spaces are shrunk by the amount that the uncompressed portion of the shell intrudes as well as the Young's modulus deformation of resilient material from directly between the particles laterally into the interstitial space. In other words, the shell material slightly squeezes into the interstitial space, lessening the pore size.

The compressibility of the shells can be used for fine tuning of pore sizes after the silica colloidal crystal structure is assembled. For example, the sides and top of the structure can be compressed with a mechanical or electrical actuator, causing the voids to shrink by a small amount. Likewise, stretching the structure from the sides can increase pore size.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications, websites, and databases cited herein are hereby incorporated by reference in their entireties for all purposes.

1. An electrophoresis system useful for a Western immunoassay, said electrophoresis system comprising:
a substrate comprising a plurality of colloidal nanoparticles;
a power supply for applying a voltage along said substrate; and
a means for applying a detection reagent to the substrate.

2. The electrophoresis system of claim 1, wherein said nanoparticles comprise silica.

3. The electrophoresis system of claim 2, wherein said silica nanoparticles are arranged in a crystal structure.

4. The electrophoresis system of claim 1, wherein each of said plurality of nanoparticles is spherical and between about 1 nm to about 2000 nm in diameter.

5. The electrophoresis system of claim 1, wherein said nanoparticles are coated.

6. The electrophoresis system of claim 5, wherein said nanoparticles are coated with a polymer.

7. The electrophoresis system of claim 6, wherein said polymer is a hydrophilic polymer.

8. The electrophoresis system of claim 7, wherein said hydrophilic polymer is a member selected from the group consisting of a polyalcohol, a polyoxyethylene, a polyether, a polyamide, a polyimide, a polycarboxylate, a polysulfate, a polysufonate, a polyphosphate, a polyphosphonate and a combination thereof.

9-10. (canceled)

11. The electrophoresis system of claim 7, wherein said hydrophilic polymer layer is further functionalized for immobilization of an analyte.

12. (canceled)

13. The electrophoresis system of claim 11, wherein immobilization of said analyte is effectuated by UV light or by a change in pH.

14. The electrophoresis system of claim 1, wherein said substrate has an x-axis and a y-axis and said voltage is configured to resolve or separate an analyte along said x-axis as a first dimension.

15. The electrophoresis system of claim 14, wherein said system is configured to resolve or separate said analyte along the y-axis as a second dimension.

16-17. (canceled)

18. The electrophoresis system of claim 15, wherein said resolution or separation in said second dimension is performed using a member selected from the group consisting of electrophoresis, isoelectric focusing, and chromatography.

19. (canceled)

20. A Western immunoassay method, said method comprising:
resolving at least one analyte on a substrate comprising a plurality of colloidal nanoparticles;
immobilizing said at least one analyte on said substrate to form an immobilized said at least one analyte; and
detecting said immobilized said at least one analyte.

21-29. (canceled)

30. The method of claim 20, wherein said substrate has an x-axis and a y-axis, wherein a power supply applies a voltage along said substrate to resolve said at least one analyte along said x-axis as a first dimension.

31. The method of claim 30, wherein said at least one analyte is resolved along the y-axis as a second dimension.

32-33. (canceled)

34. The method of claim 31, wherein said resolution or separation in said second dimension is performed using a member selected from the group consisting of electrophoresis, isoelectric focusing, and chromatography.

35. A kit, said kit comprising:
a substrate comprising a plurality of colloidal nanoparticles;
a detection reagent; and
instructions for use.

36. The kit of claim 35, wherein said detection reagent comprises an antibody.

37. The kit of claim 35, wherein said antibody comprises a primary antibody and a secondary antibody.
